(19) United States
(12) Patent Application Publication
(10) Pub. No.: US 2007/0164932 A1
(43) Pub. Date: Jul. 19, 2007

(54) Plasma display apparatus and method of driving the same

(75) Inventor: Seonghak Moon, Seoul (KR)

Correspondence Address: KED & ASSOCIATES, LLP, P.O. Box 221200, Chantilly, VA, 20153-1200, US

(73) Assignee: LG Electronics Inc.

(21) Appl. No.: 11/653,375

(22) Filed: Jan. 16, 2007

(30) Foreign Application Priority Data
Jan. 17, 2006 (KR) 10-2006-0004736

(51) Int. Cl. G09G 3/28

(52) U.S. Cl. 345/63

(57) ABSTRACT

A plasma display apparatus and a method of driving the same are disclosed. The plasma display apparatus includes a plasma display panel, a driver that supplies a driving voltage to the plasma display panel, and a controller. After a luminance difference between a first area and a second area of the plasma display panel is maintained at a first luminance difference for a predetermined period of time, the controller compensates for a luminance of at least one of the first area or the second area when video data of an equal gray level is input in the first area and the second area.

This application claims the benefit of Korean Patent Application No. 10-2006-0004736 filed on Jan. 17, 2006, which is hereby incorporated by reference.

### BACKGROUND

1. Field

This document relates to a display apparatus, and more particularly, to a plasma display apparatus and a method of driving the same.

2. Description of the Related Art

A plasma display panel has the structure in which barrier ribs formed between a front panel and a rear panel forms unit discharge cell or discharge cells. Each of the discharge cells is filled with an inert gas containing a main discharge gas such as neon (Ne), helium (He) and a mixture of Ne and He, and a small amount of xenon (Xe). The plurality of discharge cells form one pixel. For example, a red (R) discharge cell, a green (G) discharge cell, and a blue (B) discharge cell form one pixel.

When the plasma display panel is discharged by applying a high frequency voltage to the discharge cells, the inert gas generates vacuum ultraviolet rays, which thereby cause phosphors formed between the barrier ribs to emit light, thus displaying an image.

The plasma display panel includes a plurality of electrodes, for example, a scan electrode, a sustain electrode, and a data electrode. A plurality of drivers are connected to the plurality of electrodes, respectively, and thus applying driving voltages to the plurality of electrodes.

The drivers supply a reset pulse during a reset period, a scan pulse during an address period, and a sustain pulse during a sustain period to the electrodes during the driving of the plasma display panel, thereby displaying an image. Since the plasma display apparatus can be manufactured to be thin and light, it has attracted attention as a next generation display device.

In the related art plasma display apparatus thus driven, image retention occurs on the screen due to various factors affecting the discharge of the plasma display panel such as the phosphor or the remaining priming particles.

When a pattern of the same screen continues or a change in the screen is little, the image retention occurs seriously. This results in image sticking. For example, when there is no change in video data that is continuously input, or a rate of change in video data is equal to or less than a threshold rate of change of video data, the sustain pulses with the same pattern or similar patterns are applied to the same area or similar areas in the panel display surface. The state of the wall charges distributed within the discharge cell is fixed due to various factors affecting the discharge of the plasma display panel such as the phosphor or the remaining priming particles within the discharge cell. As a result, an image directly before a fixed image pattern is displayed on the display surface as image retention of a next image, thereby increasing image sticking.

### SUMMARY

In one aspect, a plasma display apparatus comprises a plasma display panel, a driver that supplies a driving voltage to the plasma display panel, and a controller that after a luminance difference between a first area and a second area of the plasma display panel is maintained at a first luminance difference for a predetermined period of time, compensates for a luminance of at least one of the first area or the second area when video data of an equal gray level is input in the first area and the second area.

In another aspect, a method of driving a plasma display apparatus comprises, after a luminance difference between a first area and a second area of a plasma display panel is maintained at a first luminance difference for a predetermined period of time, compensating for a luminance of at least one of the first area or the second area when video data of an equal gray level is input in the first area and the second area.

After the luminance difference between the first area and the second area is maintained at the first luminance difference for the predetermined period of time, the luminance of at least one of the first area or the second area may be compensated for when a gray level of video data in the second area changes to be less than a difference between a gray level of video data in the first area and the gray level of the video data in the second area.

The luminance of at least one of the first area or the second area may be compensated for by controlling the gray level of at least one of the first area or the second area.

The luminance of at least one of the first area or the second area may be compensated for by controlling the number of ON subfields in at least one of the first area or the second area.

After the luminance of at least one of the first area or the second area is compensated for, the first area or the second area may have a compensated luminance different from a luminance of the first area or the second area corresponding to the video data input from the outside.

After the luminance difference between the first area and the second area is maintained at the first luminance difference for the predetermined period of time, the luminance of the second area may be compensated for when the gray level of the video data in the second area increases.

The luminance of the second area may decrease when the gray level of the video data in the second area increases.

After the luminance difference between the first area and the second area is maintained at the first luminance difference for the predetermined period of time, the luminance of the first area may be compensated for when the gray level of the video data in the second area decreases.

The luminance of the first area may increase when the gray level of the video data in the second area decreases.

After the luminance difference between the first area and the second area is maintained at the first luminance difference for the predetermined period of time, a weight of a sustain pulse corresponding to the gray level of the video data in the first area may be different from a weight of a sustain pulse corresponding to the gray level of the video data in the second area when the video data of the equal gray level is input in the first area and the second area.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention.

FIG. 1 illustrates a plasma display apparatus according to one embodiment;

FIG. 2 illustrates a configuration of a plasma display panel according to one embodiment;

FIG. 3 illustrates an example of a method for representing a gray level of an image in the plasma display panel according to one embodiment;

FIG. 4 illustrates a driving waveform in the plasma display panel according to one embodiment;

FIGS. 5a and 5b are block diagrams of a controller of the plasma display apparatus according to one embodiment;

FIG. 6 is a flow chart of a method for compensating for image retention in the plasma display apparatus according to one embodiment;

FIGS. 7a and 7b illustrate a process for compensating for bright image retention in the plasma display apparatus according to one embodiment;

FIGS. 8a and 8b illustrate a process for compensating for dark image retention in the plasma display apparatus according to one embodiment;

FIGS. 9a and 9b illustrate a relationship between video data and screen luminance in the processes for compensating for the bright image retention and the dark image retention; and

FIGS. 10a and 10b illustrate a driving method for compensating for the bright image retention and the dark image retention in the plasma display apparatus according to one embodiment.

### DETAILED DESCRIPTION OF EMBODIMENTS

Embodiments of the present invention will be described in a more detailed manner with reference to the drawings.

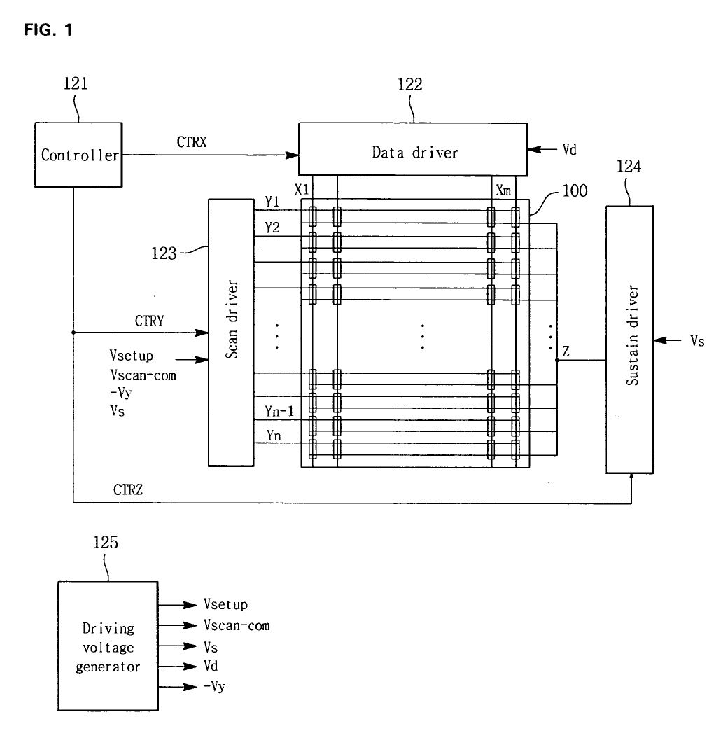

FIG. 1 illustrates a plasma display apparatus according to one embodiment.

As illustrated in FIG. 1, the plasma display apparatus according to one embodiment includes a plasma display panel 100, on which an image is displayed by processing video data input from the outside, a data driver 122, a scan driver 123, a sustain driver 124, a controller 121, and a driving voltage generator 125. The data driver 122 supplies data to data electrodes X1 to Xm formed in the plasma display panel 100. The scan driver 123 drives scan electrodes Y1 to Yn formed in the plasma display panel 100. The sustain driver 124 drives sustain electrodes Z, formed in the plasma display panel 100, being common electrodes. The controller 121 controls each of the drivers 122, 123 and 124. The driving voltage generator 125 supplies a necessary driving voltage to each of the drivers 122, 123 and 124.

A front substrate (not shown) and a rear substrate (not shown) of the plasma display panel 100 are coalesced with each other at a given distance. On the front substrate, a plurality of electrodes, for example, the scan electrodes Y1 to Yn and the sustain electrodes Z are formed in pairs. On the rear substrate, the data electrodes X1 to Xm are formed to intersect the scan electrodes Y1 to Yn and the sustain electrodes Z.

The data driver 122 receives data, which is inverse-gamma corrected and error-diffused by an inverse gamma correction circuit (not shown) and an error diffusion circuit (not shown) and then mapped in accordance with a subfield pattern previously set by a subfield mapping circuit (not shown). The data driver 122 supplies the data, which is sampled and latched under the control of the controller 121, to the data electrodes X1 to Xm.

Under the control of the controller 121, the scan driver 123 supplies a reset pulse to the scan electrodes Y1 to Yn during a reset period such that discharge cells corresponding to the whole screen is initialized. After supplying the reset pulse, the scan driver 123 supplies a scan reference voltage Vsc and a scan signal, which falls from the scan reference voltage Vsc to a negative voltage level, to the scan electrodes Y1 to Yn during an address period such that the scan electrode lines are scanned.

The scan driver 123 supplies a sustain pulse to the scan electrodes Y1 to Yn during a sustain period such that a sustain discharge occurs within the discharge cells selected during the address period.

Under the control of the controller 121, the sustain driver 124 supplies a sustain pulse to the sustain electrodes Z during the sustain period. At this time, the scan driver 123 and the sustain driver 124 alternately operate.

The controller 121 receives a vertical/horizontal synchronization signal. The controller 121 generates timing control signals CTRX, CTRY and CTRZ required in each of the drivers 122, 123 and 124. The controller 121 supplies the timing control signals CTRX, CTRY and CTRZ to each of the corresponding drivers 122, 123 and 124 to control the drivers 122, 123 and 124. The timing control signals CTRX applied to the data driver 122 includes a sampling clock for sampling data, a latch control signal, and a switch control signal for controlling on/off time of an energy recovery circuit and a driving switch element. The timing control signals CTRY applied to the scan driver 123 includes a switch control signal for controlling on/off time of an energy recovery circuit installed in the scan driver 123 and a driving switch element. The timing control signals CTRZ applied to the sustain driver 124 includes a switch control signal for controlling on/off time of an energy recovery circuit installed in the sustain driver 124 and a driving switch element.

After a luminance difference between a first area and a second area of the plasma display panel is maintained at a first luminance difference for a predetermined period of time, the controller 121 compensates for a luminance of at least one of the first area or the second area when inputting video data of an equal gray level to the first area and the second area.

The driving voltage generator 125 generates various driving voltages such as a sustain voltage Vs, a scan reference voltage Vsc, a data voltage Va, a scan voltage −Vy, required in each of the drivers 122, 123 and 124. The driving voltages may be changed depending on a composition of a discharge gas or a structure of the discharge cells.

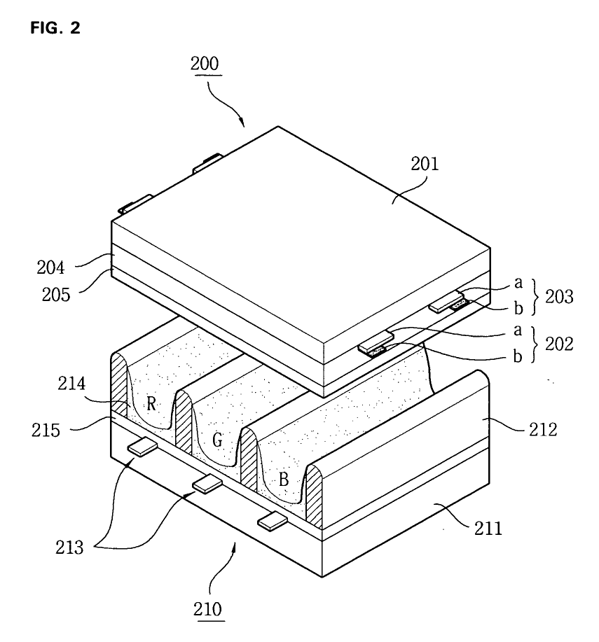

FIG. 2 illustrates a configuration of a plasma display panel according to one embodiment.

As illustrated in FIG. 2, the plasma display panel includes a front panel 200 and a rear panel 210 which are coupled in parallel to oppose to each other at a given distance therebetween. The front panel 200 includes a front substrate 201 which is a display surface. The rear panel 210 includes a rear substrate 211 constituting a rear surface. A plurality of scan electrodes 202 and a plurality of sustain electrodes 203 are formed in pairs on the front substrate 201, on which an image is displayed, to form a plurality of maintenance electrode pairs. A plurality of data electrodes 213 are arranged on the rear substrate 211 to intersect the plurality of maintenance electrode pairs.

The scan electrode 202 and the sustain electrode 203 each includes transparent electrodes 202a and 203a made of a transparent indium-tin-oxide (ITO) material and bus electrodes 202b and 203b made of a metal material. The scan electrode 202 and the sustain electrode 203 may include each either the transparent electrode or the bus electrode. The scan electrode 202 and the sustain electrode 203 generate a mutual discharge therebetween in one discharge cell and maintain light-emissions of discharge cells. The scan electrode 202 and the sustain electrode 203 are covered with one or more upper dielectric layers 204 for limiting a discharge current and providing insulation between the maintenance electrode pairs. A protective layer 205 with a deposit of MgO is formed on an upper surface of the upper dielectric layer 204 to facilitate discharge conditions.

A plurality of stripe-type or well-type barrier ribs 212 are formed on the rear substrate 211 of the rear panel 210 to form a plurality of discharge spaces, i.e., a plurality of discharge cells. The plurality of data electrodes 213 for performing an address discharge to generate vacuum ultraviolet rays are arranged in parallel to the barrier ribs 212.

An upper surface of the rear substrate 211 is coated with red (R), green (G) and blue (B) phosphors 214 for emitting visible light for an image display during the generation of the address discharge. A lower dielectric layer 215 is formed between the data electrodes 213 and the phosphors 214 to protect the data electrodes 213.

The front panel 200 and the rear panel 210 thus formed are coalesced by a sealing process such that the plasma display panel is completed. The drivers for driving the scan electrode 202, the sustain electrode 203 and the data electrode 213 are adhered to the plasma display panel to complete the plasma display apparatus.

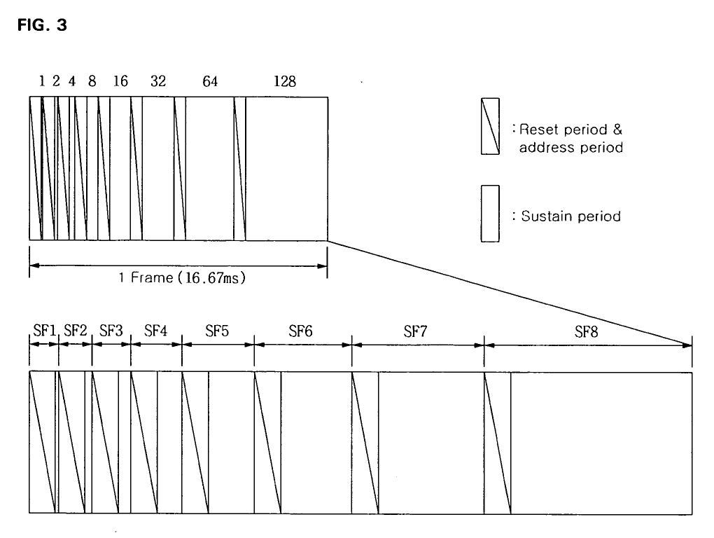

FIG. 3 illustrates an example of a method for representing a gray level of an image in the plasma display panel according to one embodiment.

As illustrated in FIG. 3, the plasma display apparatus is driven with a frame being divided into several subfields having a different number of emission times. For example, each of the subfields is subdivided into a reset period for initializing all the cells, an address period for selecting cells to be discharged, and a sustain period for representing a gray level in accordance with the number of discharges.

For example, if an image with 256-level gray scale is to be displayed, a frame period (for example, 16.67 ms) corresponding to 1/60 sec is divided into eight subfields SF1 to SF8. Each of the eight subfields SF1 to SF8 is subdivided into a reset period, an address period, and a sustain period. A duration of the reset period in a subfield is equal to a duration of the reset periods in the other subfields. A duration of the address period in a subfield is equal to a duration of the address periods in the other subfields. However, a duration of the sustain period of each subfield may be different from one another, and the number of sustain pulses assigned during the sustain period of each subfield may be different from one another. For example, the sustain period increases in a ratio of 2ⁿ (where, n=0, 1, 2, 3, 4, 5, 6, 7) in each of the subfields such that a gray level of an image is represented.

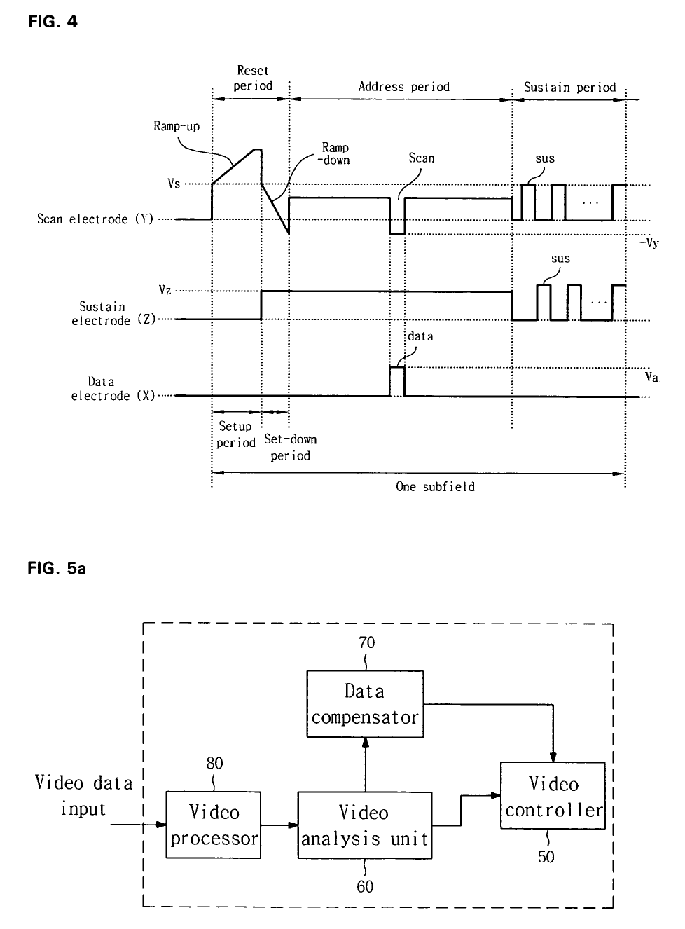

FIG. 4 illustrates a driving waveform in the plasma display panel according to one embodiment.

As illustrated in FIG. 4, the plasma display panel is driven with a frame of the screen being divided into a plurality of subfields. Each subfield is divided into a reset period for initializing all the cells, an address period for selecting cells to be discharged, and a sustain period for holding the selected cells in a discharge state.

The reset period is further divided into a setup period and a set-down period. During the setup period, a setup pulse (Ramp-up) is simultaneously supplied to all the scan electrodes Y. The setup pulse (Ramp-up) generates a weak dark discharge (i.e., a setup discharge) within the discharge cells of the whole screen.

During the set-down period, a set-down pulse (Ramp-down) is supplied to the scan electrodes Y, thereby generating a weak erase discharge within the discharge cells. Furthermore, the remaining wall charges are uniform inside the discharge cells.

During the address period, a scan pulse (Scan) with a scan voltage −Vy is sequentially supplied to the scan electrodes Y and, at the same time, a data pulse (data) synchronized with the scan pulse (Scan) is supplied to the data electrodes X. As the voltage difference between the scan pulse (Scan) and the data pulse (data) is added to the wall voltage generated during the reset period, the address discharge occurs within the discharge cells to which the data pulse (data) is supplied. Wall charges are formed inside the cells selected by performing the address discharge.

A positive voltage Vz is applied to the sustain electrode Z such that an erroneous discharge does not occur between the scan electrode Y and the sustain electrode Z.

During the sustain period, a sustain pulse (sus) is alternately supplied to the scan electrode Y and the sustain electrode Z.

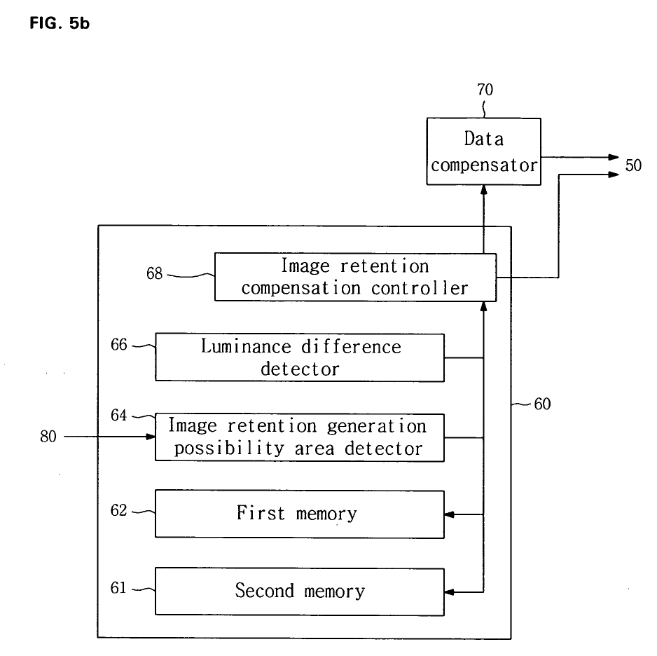

FIGS. 5a and 5b are block diagrams of a controller of the plasma display apparatus according to one embodiment.

As illustrated in FIG. 5a, the controller includes a video processor 80, a video analysis unit 60, a data compensator 70, and a video controller 50.

The video processor 80 performs a gamma correction process, an error diffusion process, and the like, to convert a video signal input from the outside into input video data suitable for a property of the plasma display panel.

The video analysis unit 60 analyzes the video data output from the video processor 80, and checks an image retention generation possibility area when there is a little change in luminance on the screen for a predetermined period of time. Further, the video analysis unit 60 checks a situation (for example, the change of scene) when the image retention occurs actually, and determines a type of the image retention.

The video analysis unit 60 recognizes data of a discharge cell corresponding to each of the first and second areas of the plasma display panel. For example, after the luminance difference between the first area and the second area is maintained at the first luminance difference for the predetermined period of time, the video analysis unit 60 outputs a signal for compensating for a luminance of the first area or the second area to the data compensator 70 when there is a change in video data of the second area.

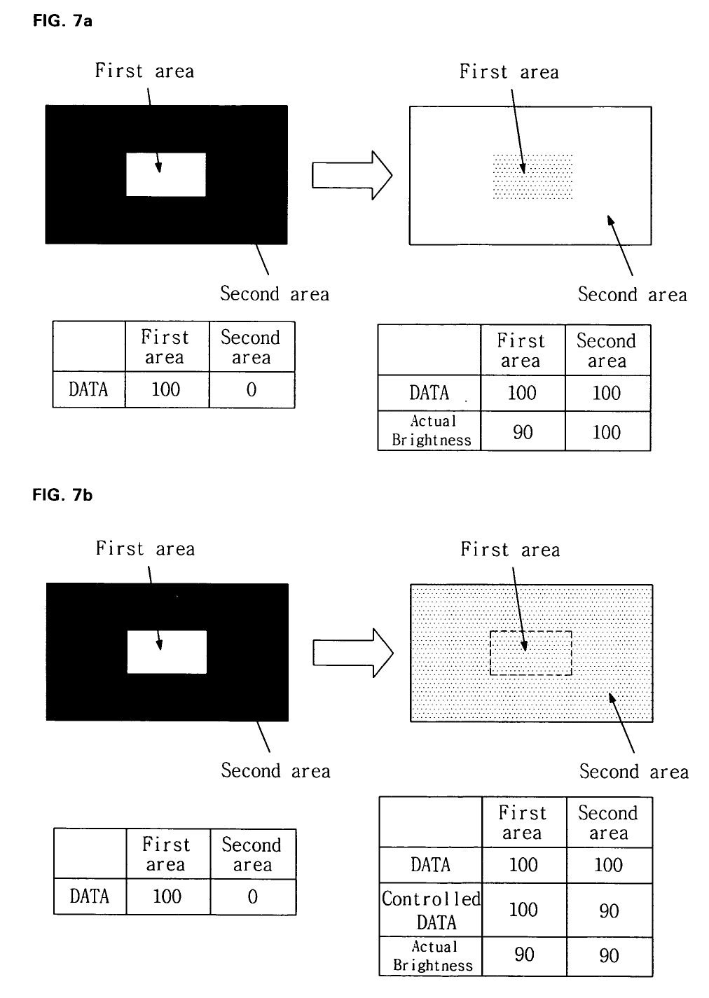

After the luminance difference between the first area and the second area is maintained at the first luminance difference for the predetermined period of time, the video analysis unit 60 can compensate for a luminance of at least one of the first area or the second area when inputting video data of an equal gray level to the first area and the second area. This description will be described later with reference to FIGS. 7a and 7b.

The luminance of the first area or the second area can be compensated for using various methods. For example, the luminance of the first area or the second area is compensated for by changing a gray level corresponding to the first area or the second area, or by controlling a driving voltage input to the first area or the second area.

The number of sustain pulses can be controlled using the driving voltage. For example, after the luminance difference between the first area and the second area is maintained at the first luminance difference for the predetermined period of time, the number of sustain pulses is controlled so that a weight of a sustain pulse corresponding to a gray level of video data in the first area is different from a weight of a sustain pulse corresponding to a gray level of video data in the second area when inputting video data of an equal gray level to the first area and the second area.

In a case where there is the possibility of the generation of image retention based on the analysis of the video analysis unit 60, the data compensator 70 compensates for the input video data or the video controller 50 controls a waveform of the driving voltage.

FIG. 5b illustrates a driving method of the video analysis unit 60 in detail. The video analysis unit 60 includes an image retention generation possibility area detector 64, a luminance difference detector 66, an image retention compensation controller 68, a first memory 62, and a second memory 61.

The image retention generation possibility area detector 64 distinguishes an area having a luminance difference from the areas on the screen based on the input video data, and judges positions of image areas displayed on the screen. Further, the image retention generation possibility area detector 64 detects an area where there is the possibility of the generation of image retention by judging whether the image areas are displayed on the screen without a large change in the luminance for a predetermined period of time

The image retention generation possibility area detector 64 divides the screen into a plurality of unit areas, and judges the possibility of the generation of image retention in each unit area. In this case, a method for producing information of each unit area may be used. A method for producing information on the possibility of the generation of image retention in each discharge cell or each pixel may be used. A method for producing information on the possibility of the generation of image retention based on the sampled plurality of discharge cells on the screen may be used.

The first memory 61 writes history of the video data of each discharge cell or each unit area such that it is judged whether a state of each of the video data is maintained within a predetermined rate of change for the predetermined period of time. The first memory 61 may write the positions of the areas on the screen detected by the image retention generation possibility area detector 64.

The luminance difference detector 66 compares newly input video data with previously input video data in the image retention generation possibility area detected by the image retention generation possibility area detector 64, and judges a change in the video data.

When the luminance difference detector 66 judges the possibility of the generation of image retention, the image retention compensation controller 68 sends video data and a compensation command signal to the data compensator 70 to compensate for image retention in the image retention generation possibility area. When the luminance difference detector 66 judges that there is no possibility of the generation of image retention, the image retention compensation controller 68 directly sends video data to the video controller 50 without passing through the data compensator 70. Then, an image display driving is achieved.

In a compensation process of the video data performed in the data compensator 70, a compensation range of the video data may vary according to a luminance difference level between the image retention generation possibility area and the periphery area, or a changed luminance difference level depending on newly input video data stored in the second memory 61, or a history (for example, time where a stop image is maintained) of the image area displayed in the previous image retention generation possibility area.

Since a degree of the image retention varies according to a time when a stop image is maintained due to previous video data or the luminance difference between the previous video data and a changed video data due to the image retention, a compensation rage of the video data may vary to be suitable for the degree of the image retention. The second memory 61 may store a look-up table provided based on a pre-experiment, and the like, for determining the compensation rage of the video data.

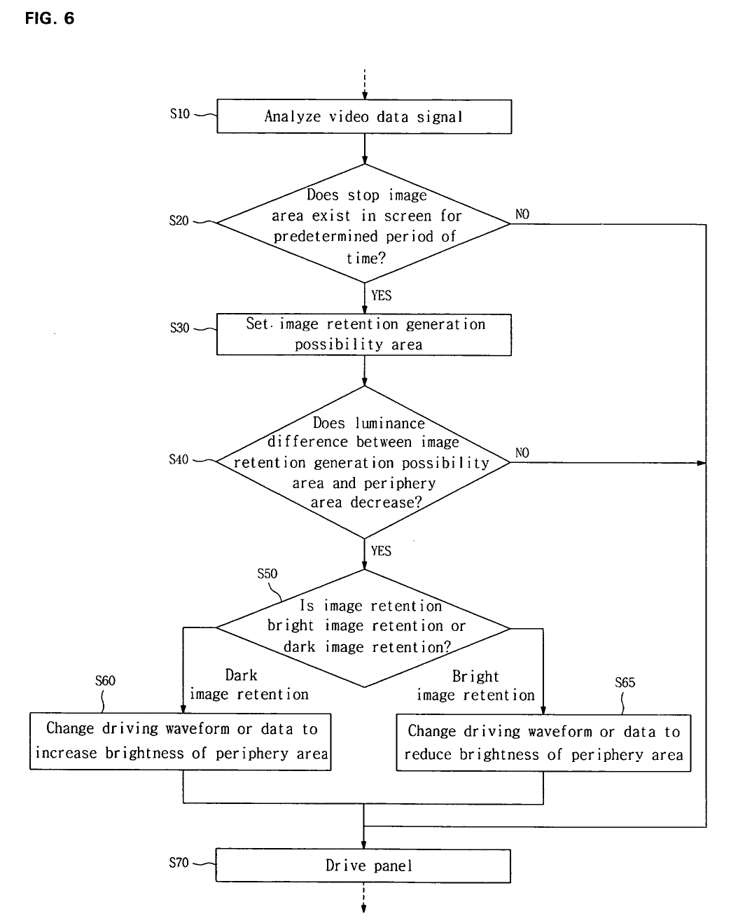

FIG. 6 is a flow chart of a method for compensating for image retention in the plasma display apparatus according to one embodiment.

As illustrated in FIG. 6, a video data signal is analyzed in step S10, and it is judged in step S20 whether a stop image area exists in the screen for a predetermined period of time. For this, a method for dividing the areas on the screen into a plurality of unit areas, a method for performing the judgment in each discharge cell or each pixel, or a method for judging the sampled plurality of discharge cells on the screen as a representation may be used. Information and positions of the stop image area and a periphery area are recognized, and then the stop image area is set as an image retention generation possibility area in step S30.

When the change of scene occurs by the continuous input of the video data, the luminance difference between the video data in the previously set image retention generation possibility area and the video data in the periphery area decreases. This may result in the generation of the image retention. The possibility of the generation of the image retention is judged in step S40 by judging the luminance difference between the previously set image retention generation possibility area and the periphery area based on newly input video data.

It is determined in step S50 whether the generated image retention is bright image retention or dark image retention. Image retention generated when the luminance difference between a predetermined image area and the periphery area decreases by increasing a luminance of the predetermined image area on the screen is recognized as bright image retention.

For example, after the luminance difference between the first area and the second area is maintained at the first luminance difference for the predetermined period of time, a gray level of the video data in the second area may increase. In other words, after the luminance difference between the first area and the second area is maintained at the first luminance difference for the predetermined period of time, when there is a change in a gray level of the video data in the second area so that the gray level of the video data in the second area is less than a difference between gray levels of the video data of the first area and the second area, image retention may occur. When the gray level of the video data in the second area increases, the luminance of the second area increases and the luminance difference between the first area and the second area is less than the first luminance difference. This may result in the generation of the bright image retention. At this time, the luminance of the second area is compensated for such that the luminance of the screen is compensated for. For example, as the gray level of the video data in the second area increases, the luminance of the second area decreases such that the luminance difference between the first area and the second area caused by the image retention is prevented.

As above, when the generated image retention is recognized as the bright image retention, a waveform of the driving voltage or the gray level of the periphery area changes in step S65 so that a brightness of the periphery area is less than a brightness corresponding to the input video data. Accordingly, the luminance of the periphery area is compensated for.

Image retention generated when the luminance difference between a predetermined image area and the periphery area decreases by decreasing a luminance of the predetermined image area on the screen is recognized as dark image retention.

For example, after the luminance difference between the first area and the second area is maintained at the first luminance difference for the predetermined period of time, a gray level of the video data in the second area may decrease. In other words, after the luminance difference between the first area and the second area is maintained at the first luminance difference for the predetermined period of time, when there is a change in a gray level of the video data in the second area so that the gray level of the video data in the second area is less than a difference between gray levels of the video data of the first area and the second area, image retention may occur. When the gray level of the video data in the second area decreases, the luminance of the second area increases and the luminance difference between the first area and the second area is less than the first luminance difference. This may result in the generation of the dark image retention. At this time, the luminance of the second area is compensated for such that the luminance of the screen is compensated for. For example, as the gray level of the video data in the second area decreases, the luminance of the first area increases such that the luminance difference between the first area and the second area caused by the image retention is prevented.

As above, when the generated image retention is recognized as the dark image retention, a waveform of the driving voltage or the gray level of the periphery area changes in step S60 so that a brightness of the periphery area is more than a brightness of the input video data. Accordingly, the luminance of the periphery area is compensated for.

FIGS. 7a and 7b illustrate a process for compensating for bright image retention in the plasma display apparatus according to one embodiment.

FIG. 7a illustrates a generation situation of bright image retention. As illustrated in the left side of FIG. 7a, the second area was displayed in black and the first area being a middle window portion was displayed in white for a predetermined period of time so that the luminance difference between the first area and the second area is equal to the first luminance difference. Afterwards, when the gray level of the video data in the second area increases such that the second area changes into white, the luminance of an image actually displayed on the first area decreases with regard to the gray level of the same video data. For example, the actually represented brightness with regard to gray level of the video data of ‘100’ in the first area may be reduced to “90”. In the other hand, the second area has the brightness (i.e., 100) corresponding to the gray level of the input video data. Therefore, the first and second areas do not have the same brightness, and the first area is darker than the second area. This is called bright image retention. A cause of the bright image retention is not clearly confirmed, but the cause of the bright image retention is estimated to be a reduction in the luminance in the first area caused by the degradation of the phosphor in the first area.

As illustrated in FIG. 7b, since the luminance of the second area increases sharply and the luminance of the first area decreases, the bright image retention occurs on the screen. To compensate for the bright image retention, the luminance of the second area may decrease. For example, the gray level of the second area is reduced to be less than the gray level of the input video data such that the luminance of the second area can be reduced. As above, the luminance of the second area is compensated for such that the luminances in each of the first area and the second area on the screen are equal to each other. Accordingly, the accuracy of the image display in accordance with the video data input from outside is improved.

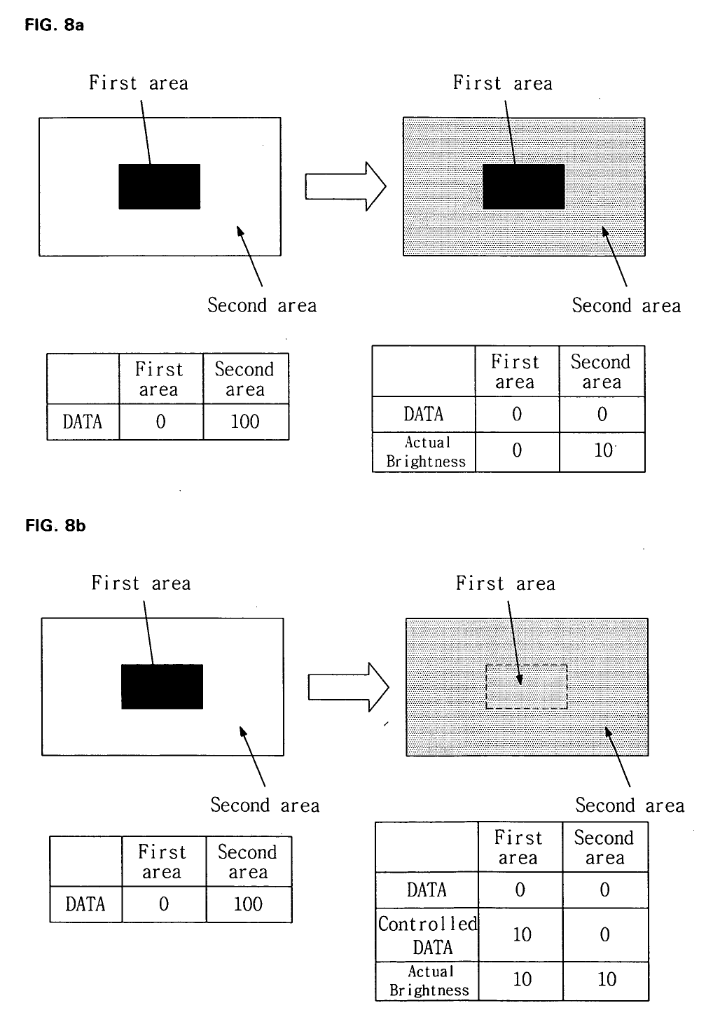

FIGS. 8a and 8b illustrate a process for compensating for dark image retention in the plasma display apparatus according to one embodiment.

FIG. 8a illustrates a generation situation of dark image retention. As illustrated in the left side of FIG. 8a, the second area was displayed in white and the first area being a middle window portion was displayed in black for a predetermined period of time. Afterwards, when the gray level of the video data in the second area decreases such that the second area changes into black, a brightness of the second area does not completely change into black and the second area has a predetermined brightness. For example, the input image data has a low gray level (for example, 0) in both the first area and the second area. However, there is a predetermined brightness on the actual screen due to the image retention in the second area. For example, the first area has a brightness of 0, and the second area has a brightness of 10. The first area is displayed more remarkably than the second area. This is called dark image retention. A cause of the dark image retention is not clearly confirmed, but the cause is estimated to be the remaining priming particles or a temperature rising.

As illustrated in FIG. 8b, since the luminance of the second area decreases sharply and the luminance of the second area is maintained to be more than the luminance of the first area, the brightness of the second area is more than the brightness of the first area when the same video data is input. To compensate for this, the luminance of the first area may increase. For example, the gray level of the second area increases to be more than the gray level of the input video data such that the luminance of the first area can be reduced. As above, the luminance of the first area is compensated for such that the luminances in each of the first area and the second area on the screen are equal to each other. Accordingly, the accuracy of the image display in accordance with the video data input from outside is improved.

As described above, after the luminance difference between the first area and the second area is maintained at the first luminance difference for the predetermined period of time, the image retention occurs when the video data of the same gray level is input in the first area and the second area. The luminance of at least one of the first area or the second area can be compensated for. When the luminance of at least one of the first area or the second area is compensated for, the first area or the second area has a compensated luminance different from a luminance of the first area or the second area corresponding to the video data input from the outside. Accordingly, an image is accurately displayed through the video data input from the outside.

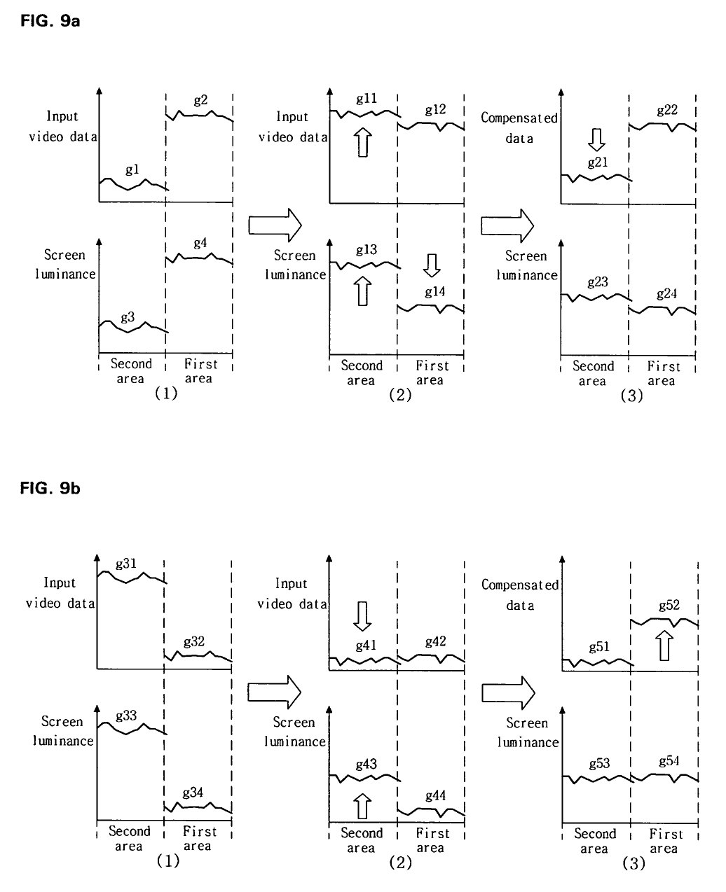

FIGS. 9a and 9b illustrate a relationship between video data and screen luminance in the processes for compensating for the bright image retention and the dark image retention.

In a process for compensating for the bright image retention, as illustrated in (1) of FIG. 9a, after the luminance between the first area and the second area is maintained at a great luminance difference (g3, g4) depending on input video data (g1, g2) for a predetermined period of time, an actual luminance (g13, g14), as illustrated in the lower end of (2) in FIG. 9a, is displayed on the screen due to the image retention when the input video data (g1, g2) changes sharply into video data (g11, g12). In other words, a luminance (g14) of the first area which was previously maintained at the high luminance is less than the luminance (g4) of the input video data such that the luminance (g14) of the first area is relatively less than a luminance (g13) of the second area.

To compensate for the bright image retention, as illustrated in (3) of FIG. 9a, video data (g21) or a driving voltage waveform is compensated for to reduce the luminance (g13) of the second area on the screen. Therefore, a ratio of a difference between an actual luminance (g23, g24) of the first area and the second area is controlled to be equal to a ratio of a luminance difference set depending on the input video data (g11, g12).

In a process for compensating for the dark image retention, as illustrated in (1) of FIG. 9b, after the luminance between the first area and the second area is maintained at a great luminance difference (g33, g34) depending on input video data (g31, g32) for a predetermined period of time, an actual luminance (g43, g44), as illustrated in the lower end of (2) in FIG. 9b, is displayed on the screen due to the image retention when the input video data (g31, g32) changes sharply into video data (g41, g42). In other words, a luminance (g43) of the second area which was previously maintained at the high luminance is more than the luminance of the input video data such that the luminance (g44) of the first area is relatively less than a luminance (g43) of the second area.

To compensate for the dark image retention, as illustrated in (3) of FIG. 9b, video data (g52) or a driving voltage waveform is compensated for to increase the luminance of the first area on the screen. Therefore, a ratio of a difference between an actual luminance (g53, g54) of the first area and the second area is controlled to be equal to a ratio of a luminance difference set depending on the input video data (g41, g42).

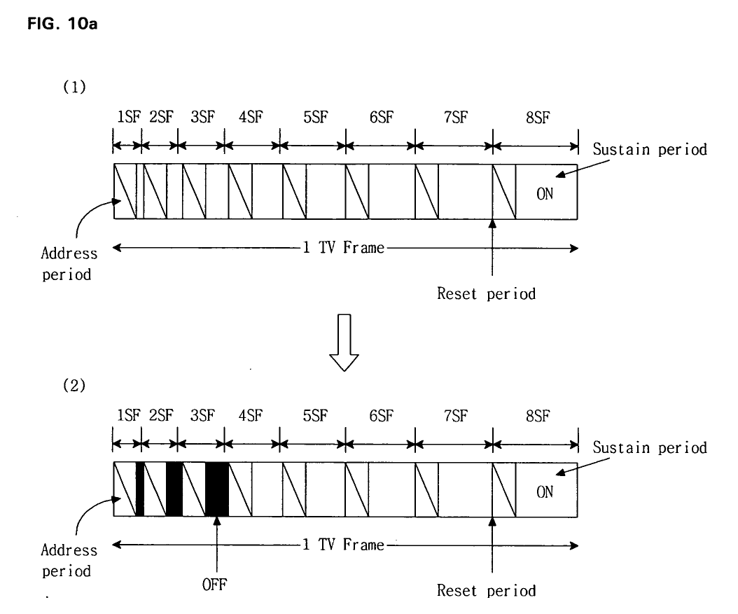

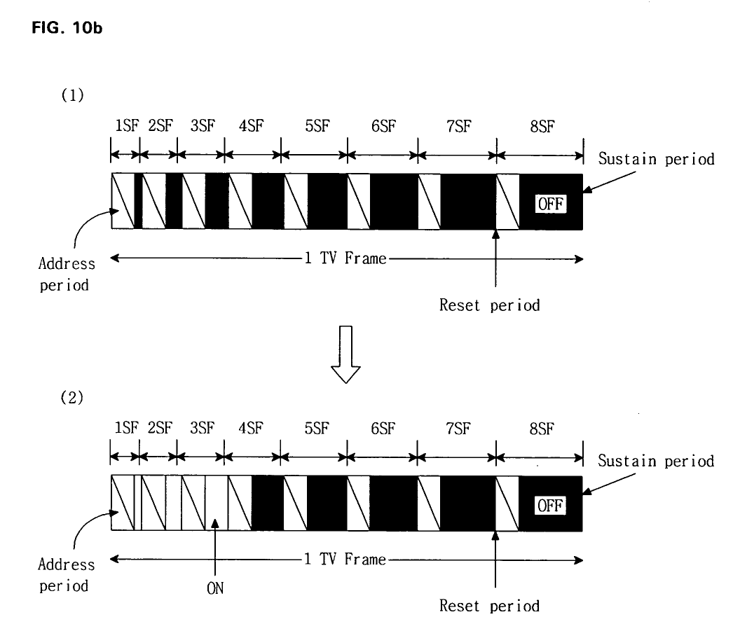

As above, the method for compensating for the luminance, that does not correspond to the input video data due to the image retention, is not limited to the control of the gray level of the video data. For example, the luminance of the first area or the second area can be compensated for by controlling the driving voltage. This will be described in detail with reference to FIGS. 10a and 10b.

FIGS. 10a and 10b illustrate a driving method for compensating the bright image retention and the dark image retention in the plasma display apparatus according to one embodiment.

FIG. 10a illustrates the control of a driving voltage waveform for compensating for the bright image retention. For example, after the luminance difference between the first area and the second area is maintained at the first luminance difference for the predetermined period of time, the luminance of at least one of the first area or the second area is compensated for by controlling the number of ON subfields in at least one of the first area or the second area when video data of an equal gray level is input in the first area and the second area.

In other words, each subfield has a predetermined sustain pulse weight. The same number of sustain pulses is input to each subfield, but the number of sustain pulses contributing in light emission may vary by controlling the number of ON subfields. The number of sustain pulses contributing in light emission may vary by controlling the number of ON subfields on in the first area or the second area. In this case, the sustain pulse weight depending on the gray level of the video data in the first area may be different from the sustain pulse weight depending on the gray level of the video data in the second area.

For example, in a case of generating bright image retention, a driving voltage waveform newly applied to the periphery area may be a driving voltage waveform of a high gray level, as illustrated in (1) of FIG. 10a. In a case where all the subfields are turned on, an actual luminance of the periphery area may be less than the previously set luminance of the input video data to compensate for the bright image retention. As illustrated in (2) of FIG. 10a, an error of the luminance due to the image retention is compensated for by reducing the actual luminance of the periphery area.

FIG. 10b illustrates the control of a driving voltage waveform for compensating for the dark image retention. In a case of generating dark image retention, a driving voltage waveform newly applied to an area, that was previously maintained at a low gray level, may be a driving voltage waveform of a low gray level, as illustrated in (1) of FIG. 10b. In a case where all the subfields are turned off, an actual luminance of the area that is maintained at the low gray level may be more than the previously set luminance of the input video data to compensate for the dark image retention. As illustrated in (2) of FIG. 10b, the luminance difference due to the image retention is compensated for by increasing the actual luminance of the area.

A change in the driving waveform follows the control of the video data. For example, a data driving waveform during an address period depending on the control of the video data is controlled to be different from the data driving waveform previously set depending on the input video data. Therefore, the number of sustain pulses contributing in light emission among sustain pulses applied for representing a gray level in each frame may vary.

As above, according to the embodiment, image retention that may occur depending on a predetermined pattern of video data displayed on the plasma display panel is prevented by compensating a luminance of a predetermined area of the screen such that more accurate image is displayed.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus comprising:
a plasma display panel;
a driver that supplies a driving voltage to the plasma display panel; and
a controller that after a luminance difference between a first area and a second area of the plasma display panel is maintained at a first luminance difference for a predetermined period of time, compensates for a luminance of at least one of the first area or the second area when video data of an equal gray level is input in the first area and the second area.

2. The plasma display apparatus of claim 1, wherein after the luminance difference between the first area and the second area is maintained at the first luminance difference for the predetermined period of time, the controller compensates for the luminance of at least one of the first area or the second area when a gray level of video data in the second area changes to be less than a difference between a gray level of video data in the first area and the gray level of the video data in the second area.

3. The plasma display apparatus of claim 2, wherein the controller compensates for the luminance of at least one of the first area or the second area by controlling the gray level of at least one of the first area or the second area.

4. The plasma display apparatus of claim 2, wherein the controller compensates for the luminance of at least one of the first area or the second area by controlling the number of ON subfields in at least one of the first area or the second area.

5. The plasma display apparatus of claim 2, wherein after the luminance of at least one of the first area or the second area is compensated for, the first area or the second area has a compensated luminance different from a luminance of the first area or the second area corresponding to the video data input from the outside.

6. The plasma display apparatus of claim 2, wherein after the luminance difference between the first area and the second area is maintained at the first luminance difference for the predetermined period of time, the controller compensates for the luminance of the second area when the gray level of the video data in the second area increases.

7. The plasma display apparatus of claim 6, wherein the controller reduces the luminance of the second area when the gray level of the video data in the second area increases.

8. The plasma display apparatus of claim 2, wherein after the luminance difference between the first area and the second area is maintained at the first luminance difference for the predetermined period of time, the controller compensates for the luminance of the first area when the gray level of the video data in the second area decreases.

9. The plasma display apparatus of claim 8, wherein the controller increases the luminance of the first area when the gray level of the video data in the second area decreases.

10. The plasma display apparatus of claim 4, wherein after the luminance difference between the first area and the second area is maintained at the first luminance difference for the predetermined period of time, a weight of a sustain pulse corresponding to the gray level of the video data in the first area is different from a weight of a sustain pulse corresponding to the gray level of the video data in the second area when the video data of the equal gray level is input in the first area and the second area.

11. A method of driving a plasma display apparatus comprising:
after a luminance difference between a first area and a second area of a plasma display panel is maintained at a first luminance difference for a predetermined period of time, compensating for a luminance of at least one of the first area or the second area when video data of an equal gray level is input in the first area and the second area.

12. The method of claim 11, wherein after the luminance difference between the first area and the second area is maintained at the first luminance difference for the predetermined period of time, the luminance of at least one of the first area or the second area is compensated for when a gray level of video data in the second area changes to be less than a difference between a gray level of video data in the first area and the gray level of the video data in the second area.

13. The method of claim 12, wherein the luminance of at least one of the first area or the second area is compensated for by controlling the gray level of at least one of the first area or the second area.

14. The method of claim 12, wherein the luminance of at least one of the first area or the second area is compensated for by controlling the number of ON subfields in at least one of the first area or the second area.

15. The method of claim 12, wherein after the luminance of at least one of the first area or the second area is compensated for, the first area or the second area has a compensated luminance different from a luminance of the first area or the second area corresponding to the video data input from the outside.

16. The method of claim 12, wherein after the luminance difference between the first area and the second area is maintained at the first luminance difference for the predetermined period of time, the luminance of the second area is compensated for when the gray level of the video data in the second area increases.

17. The method of claim 16, wherein the luminance of the second area decreases when the gray level of the video data in the second area increases.

18. The method of claim 12, wherein after the luminance difference between the first area and the second area is maintained at the first luminance difference for the predetermined period of time, the luminance of the first area is compensated for when the gray level of the video data in the second area decreases.

19. The method of claim 18, wherein the luminance of the first area increases when the gray level of the video data in the second area decreases.

20. The method of claim 14, wherein after the luminance difference between the first area and the second area is maintained at the first luminance difference for the predetermined period of time, a weight of a sustain pulse corresponding to the gray level of the video data in the first area is different from a weight of a sustain pulse corresponding to the gray level of the video data in the second area when the video data of the equal gray level is input in the first area and the second area.
